(19) United States
(12) Patent Application Publication
(10) Pub. No.: US 2005/0147386 A1
(43) Pub. Date: Jul. 7, 2005

(54) Data storage medium storing multiple video data with different formats and apparatus for reproducing data from data storage medium

(75) Inventors: Kil-soo Jung, Hwaseong-si (KR); Seong-Jin Moon, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/009,519

(22) Filed: Dec. 13, 2004

(30) Foreign Application Priority Data
Dec. 12, 2003 (KR) 2003-90573

(51) Int. Cl. H04N 5/76

(52) U.S. Cl. 386/95; 386/108; 386/131

(57) ABSTRACT

A data storage medium in which multiple video data having different formats are recorded, an apparatus for reproducing the multiple video data from a data storage medium, and a method of reproducing the multiple video data from a data storage medium. The data storage medium on which video data is recordable, includes: video source format type information which determines whether stored video data is 50 Hz video data or 60 Hz video data. When multiple video data having different formats are stored, the multiple video data are all 60 Hz video data or 50 Hz video data.

### CROSS-REFERENCE TO RELATED APPLICATION

This application claims the benefit of Korean Patent Application No. 2003-90573, filed on Dec. 12, 2003, in the Korean Intellectual Property Office, the disclosure of which is incorporated herein by reference.

### BACKGROUND OF THE INVENTION

1. Field of the Invention

The present invention relates to a data storage medium on which video data is recorded, and, more particularly, to a data storage medium on which multiple video data with different formats is recorded, and an apparatus to reproduce the multiple video data from the data storage medium.

2. Description of Related Art

Moving image data, such as a movie, is read out and reproduced from a data storage medium where the moving image data is recorded by an apparatus to record/reproduce data. The moving image data is then displayed by a display device. Typical display devices may be classified into either 50 Hz display devices, which only process 50 Hz video data, or 60 Hz display devices, which only process 60 Hz video data. Under these conditions, since different types of moving image data differ from one another in terms of frame size and frame rate, the moving image data may be therefore subjected to different format conversion methods before being output to a display device such as those discussed above.

Therefore, in order to decode various types of video data stored in a data storage medium and then output the decoded video data to a display device, information on the formats of the various types of video data should be stored somewhere in the data storage medium so that an apparatus to reproduce data from a data storage medium may convert the various types of video data with reference to the stored information to be compatible with the display device.

### BRIEF SUMMARY

An aspect of the present invention provides a data storage medium on which multiple video data having different formats is recorded, and an apparatus to reproduce the multiple video data from the data storage medium.

According to an aspect of the present invention, a data storage medium on which video data is recorded stores video source format type information which determines whether the video data is 50 Hz video data or 60 Hz video data. If the data storage medium stores multiple video data having different formats, the multiple video data are all 60 Hz video data or 50 Hz video data.

The multiple video data may include 60 Hz video data and 24 Hz video data or include 50 Hz video data and 24 Hz video data.

The 60 Hz video data may include one or both of 60 Hz SD video data and 60 Hz HD video data, and the 50 Hz video data may include one or both of 50 Hz SD video data and 50 Hz HD video data.

The video source format type information may include information on the frame size, frame rate or field rate, and scanning type of the video data stored in the data storage medium.

The information on the frame size of the video data stored in the data storage medium may specify whether the video data stored in the data storage medium is SD video data or HD video data.

The information on the frame rate or field rate of the video data stored in the data storage medium may specify whether the video data stored in the data storage medium has a frame rate or field rate of 60 Hz, 50 Hz, or 24 Hz.

The information on the scanning type of the video data stored in the data storage medium may specify whether the video data stored in the data storage medium is interlaced video data or progressive video data.

According to another aspect of the present invention, an apparatus to reproduce data from a data storage medium includes: a reader to read video data from a data storage medium; a decoder to decode the video data read out from the data storage medium; and a format converter to convert the decoded video data into one of 50 Hz video data and 60 Hz video data referencing video source format type information contained in the decoded video data.

If multiple video data having different formats are recorded on the data storage medium, the format converter may convert all of the multiple video data into one of 60 Hz video data and 50 Hz video data referencing video source format type information contained in each of the multiple video data.

If 24 Hz video data is recorded on the data storage medium, the format converter may convert the 24 Hz video data into one of 60 Hz video data or 50 Hz video data.

If the scanning type of the video data stored in the data storage medium is the same as a scanning type supported by a display, the format converter may bypass the corresponding video data to the display device, otherwise, the format converter may first convert the corresponding video data from interlaced video data into progressive video data or from progressive video data from interlaced video data and then may transmit the conversion results to the display.

The format converter includes a frame size converter to convert HD video data into SD video data or converts SD video data into HD video data; and a scanning type converter to convert interlaced video data into progressive video data or to convert progressive video data into interlaced video data.

According to another aspect of the present invention, a method of reproducing data from a data storage medium includes reading video data from a data storage medium; decoding the read video data; and converting the decoded video data into 50 Hz video data or 60 Hz video data according to video source format type information contained in the decoded video data.

According to another aspect of the present invention, a computer-readable storage medium encoded with processing instructions to cause a microprocessor to execute a method of reproducing data from a data storage medium reading video data from a data storage medium; decoding the read video data; and converting the decoded video data into 50 Hz video data or 60 Hz video data according to video source format type information contained in the decoded video data.

Additional and/or other aspects and advantages of the present invention will be set forth in part in the description which follows and, in part, will be obvious from the description, or may be learned by practice of the invention.

### BRIEF DESCRIPTION OF THE DRAWINGS

These and/or other aspects and advantages of the present invention will become apparent and more readily appreciated from the following detailed description, taken in conjunction with the accompanying drawings of which:

FIG. 1 is a diagram illustrating the format of progressive video data having a frame rate of n;

FIG. 2 is a diagram illustrating the format of interlaced video data having a frame rate of n and a field rate of 2n;

FIG. 3 is a diagram illustrating the format of video data stored in a data storage medium according to an embodiment of the present invention;

FIG. 4 is a diagram illustrating an example of a process of converting the format of video data to be compatible with a display device usable with the embodiment of FIG. 3;

FIG. 5A is a diagram illustrating an example of a process of converting progressive video data into interlaced video data usable with the embodiment of FIG. 3;

FIG. 5B is a diagram illustrating another example of the process of converting progressive video data into interlaced video data usable with the embodiment of FIG. 3;

FIG. 6 is a diagram illustrating a 3:2 pull-down operation usable with the embodiment of FIG. 3;

FIG. 7 is a diagram illustrating another example of the process of converting the format of video data to be compatible with a display device usable with the embodiment of FIG. 3;

FIG. 8 is a diagram illustrating the format of video data containing video source format type information; and

FIG. 9 is a block diagram of an apparatus for reproducing data from a data storage medium according to an embodiment of the present invention.

### DETAILED DESCRIPTION OF EMBODIMENT

Reference will now be made in detail to an embodiment of the present invention, examples of which are illustrated in the accompanying drawings, wherein like reference numerals refer to the like elements throughout. The embodiment is described below in order to explain the present invention by referring to the figures.

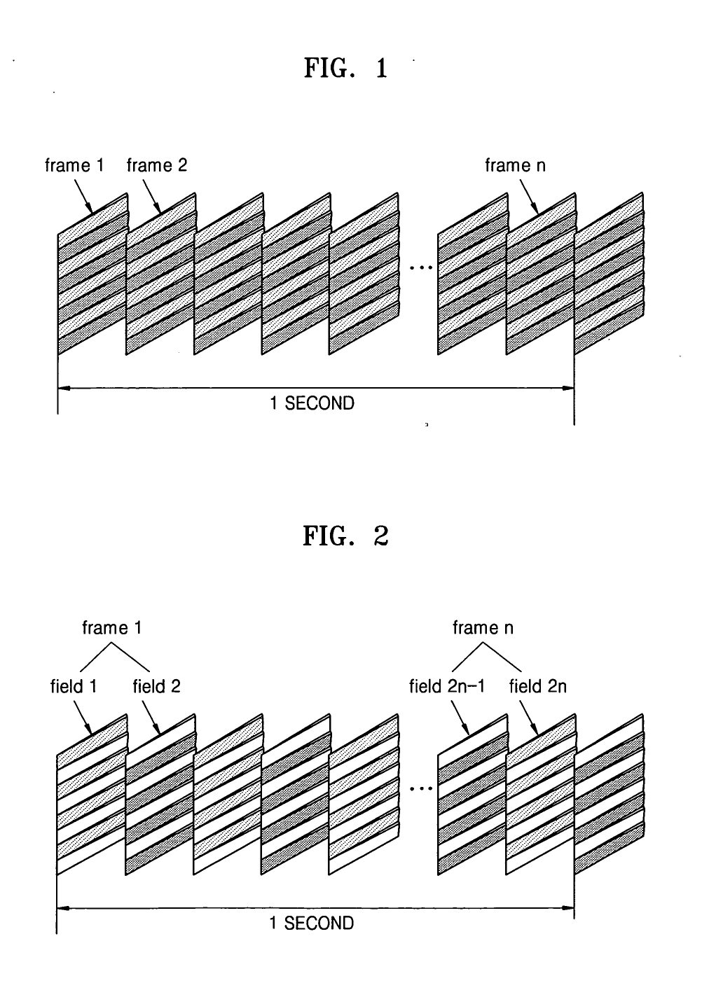

FIG. 1 is a diagram illustrating the format of video data having a frame rate of n. Video data is classified into standard definition (SD) video data or high definition (HD) video data depending on its frame size. In general, SD video data has a 720×480 or 720×576 frame size, and HD video data has a 1920×1080 or 1280×720 frame size.

Each of a plurality of still images constituting video data is called a frame. Video data is encoded on a frame-by-frame basis. A frame rate is a parameter indicating how many frames are included in each second of video data. Video data is also classified into either progressive video data or interlaced video data depending on the manner in which the video data is created, i.e., depending on whether the video data is created in a progressive scanning manner or in an interlaced scanning manner. Referring to FIG. 1, in the case of progressive video data, an even field and an odd field are integrated into a single field.

FIG. 2 is a diagram illustrating interlaced video data having a frame rate of n and a field rate of 2n. Each odd field includes odd-numbered lines of a corresponding frame, and each even field includes even-numbered lines of the corresponding frame. Referring to FIG. 2, unlike progressive video data, interlaced video data has not only a frame rate but also a field rate. Since each frame of the interlaced video data includes two fields, the field rate of the interlaced video data is two times higher than the frame rate of the interlaced video data.

In the present embodiment, the format of video data is expressed using the frame size and frame rate (or field rate) of the video data. The frame size of the video data is expressed as (the number of pixels in a horizontal line of the video data)×(the number of pixels in a vertical line of the video data)i/p where i denotes interlaced video data and p denotes progressive video data.

The frame rate or field rate of the video data is expressed as a predetermined number with the letter ‘i’ or ‘p’ attached thereto, i.e., 60i or 60p. Thus, 60i video data corresponds to interlaced video data having a field rate of 60, and 60p video data corresponds to progressive video data having a frame rate of 60.

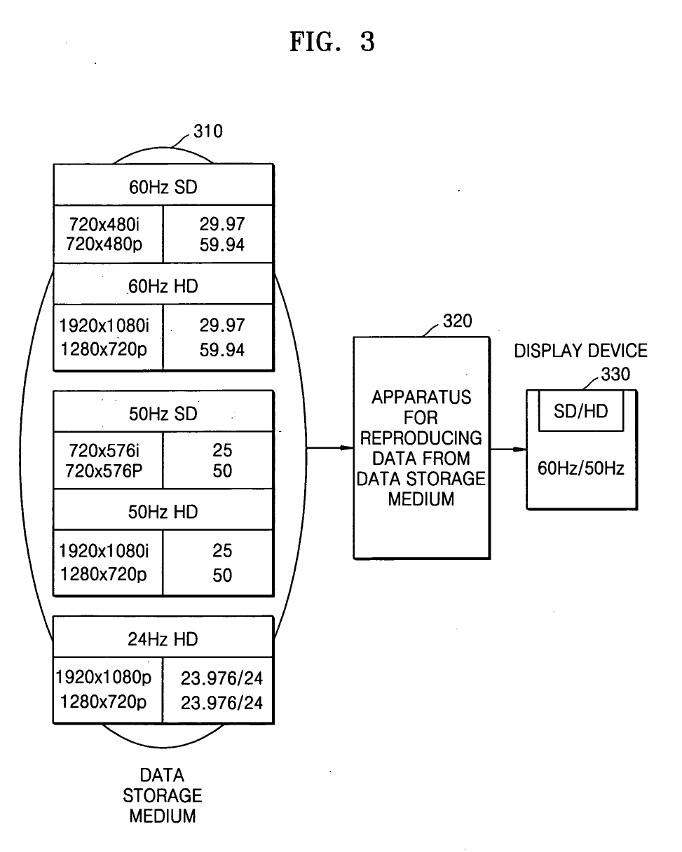

FIG. 3 is a diagram illustrating the format of video data stored in a data storage medium 310 according to an embodiment of the present invention. Video data is largely classified into 60 Hz SD video data, 60 Hz HD video data, 50 Hz SD video data, 50 Hz HD video data, or 24 Hz HD video data. Here, 60 Hz video data corresponds to video data having a frame rate of about 30 (particularly, 29.97) and/or a field rate of about 60 (particularly, 59.94), 50 Hz video data corresponds to video data having a frame rate of 25 and/or a field rate of 50 and 24 Hz video data corresponds to video data having a frame rate of 23.976 or 24.

Referring to FIG. 3, 60 Hz SD video data having a 720×480i-29.97 format, 60 Hz SD video data having a 720×480p-59.94 format, 60 Hz HD video data having a 1920×1080i-29.97 format, 60 Hz HD video data having a 1920×1080p-59.94 format, 50 Hz SD video data having a 720×576i-25 format, 50 Hz SD video data having a 720×576p-50 format, 50 Hz HD video data having a 1920×1080i-25 format, 50 Hz HD video data having a 1920×1080p-50 format, 24 Hz HD video data having a 1920×1080p-23.976 format, 24 Hz HD video data having a 1920×1080p-24 format, 24 Hz HD video data having a 1280×720p-23.976 format, and 24 Hz HD video data having a 1280×720p-24 format are recorded on the data storage medium 310.

All of the video data recorded on the data storage medium 310 are output to a display device 330 via an apparatus 320 to reproduce data from a data storage medium. The display device 330 may be a 60 Hz display device or a 50 Hz display device. The 60 Hz display device receives and then outputs an interlaced video signal having a field rate of 60 Hz or a progressive video signal having a frame rate of 60 Hz and is widely used in such countries where the National Television System Committee (NTSC) analog broadcast standard is adopted. These countries include the United States, South Korea, and Japan.

The 50 Hz display device receives and then outputs an interlaced video signal having a field rate of 50 Hz or a progressive video signal having a frame rate of 50 Hz and is widely used in most of the European countries where the Phase Alternating Line (PAL) analog broadcast standard is adopted. The display device 300 may also be classified into an SD-level display device or an HD-level display device depending on the frame size of a video signal input thereto.

The apparatus 320 to reproduce data from a data storage medium decodes video data, converts the format of the decoded video data such that the video data is compatible with the display device 330, and outputs the conversion results to the display device 330. If the format of video data that the apparatus 320 to reproduce data from a data storage medium receives is different from the format of video data that the display device 330 is able to receive, the apparatus 320 to reproduce data from a data storage medium converts the format of the video data into the format compatible with the display device 330. The conversion of the format of the video data includes a frame size conversion operation, a frame rate conversion operation, and a progressive-to-interlaced conversion operation or an interlaced-to-progressive conversion operation.

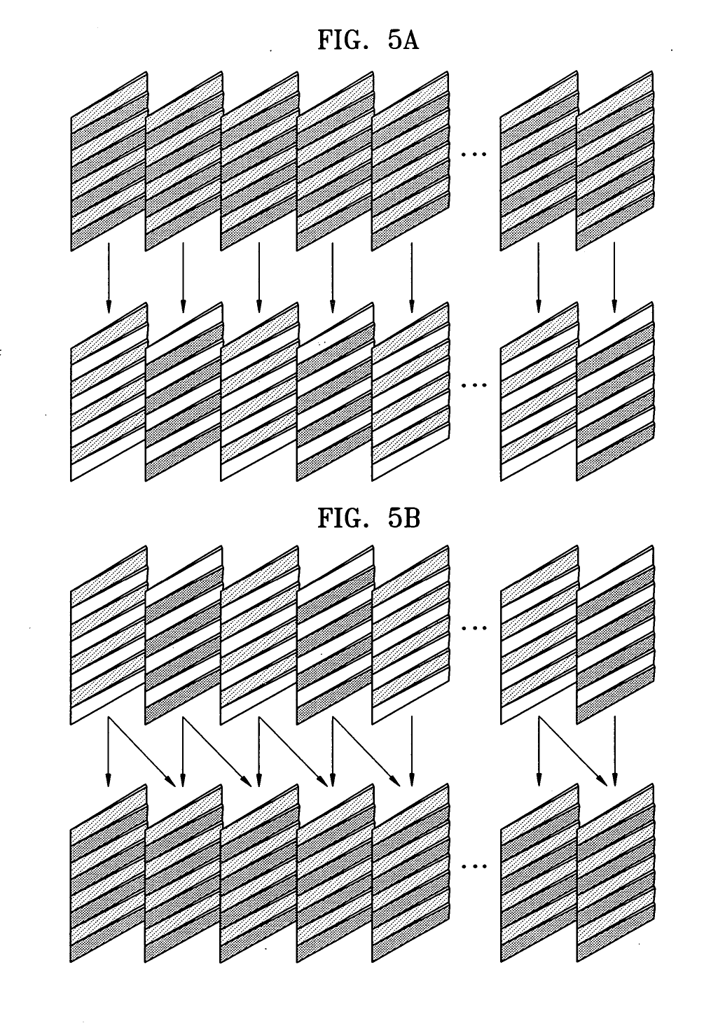

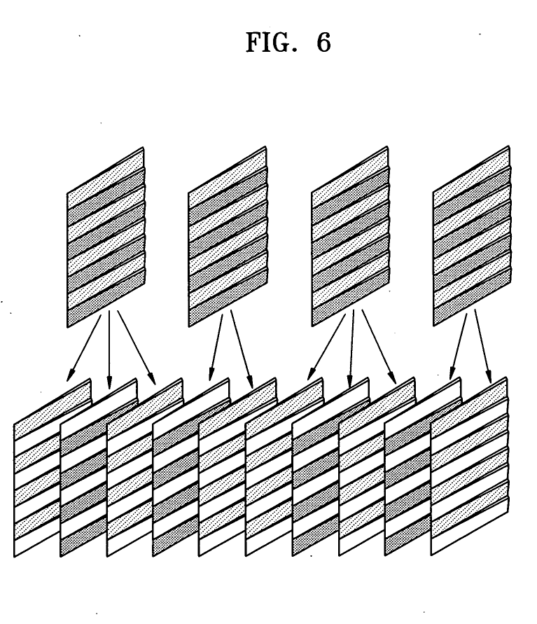

In the frame size conversion operation, video data is resized with the use of a filter while preventing deformation of the video data. In the rate conversion operation, a portion of the video data is repeatedly interpolated, an operation that will be described in further detail later with reference to FIGS. 5A through 6.

In the present embodiment, multiple video data having different formats may be recorded on a single data storage medium as long as each of the video data has the same field or frame rate. Otherwise, the multiple video data should be recorded on separate data storage media. The apparatus 320 to reproduce data from a data storage medium determines the format of each of the multiple video data and converts each of the multiple video data to be compatible with the display device 330 if corresponding video data has a different format from the format supported by the display device 330. Thereafter, the display device 330 displays the conversion results received from the apparatus 320 to reproduce data from a data storage medium.

In other words, video data having a rate of 60 Hz, which may be processed by a 60 Hz display device, is stored in a separate data storage medium from video data having a rate of 50 Hz, which can be processed by a 50 Hz display device. The 60 Hz display device is able to process one or both of 60i video data and 60p video data. In addition, the 60 Hz display device is able to process one or both of SD video data and HD video data. The data storage medium where the video data having a rate of 60 Hz is stored may further store 24 Hz HD video data. Likewise, the 50 Hz display device may be able to process one or both of 50i video data and 50p video data. In addition, the 50 Hz display device may be able to process one or both of SD video data and HD video data. The data storage medium where the video data having a rate of 50 Hz is stored may further store 24 Hz HD video data.

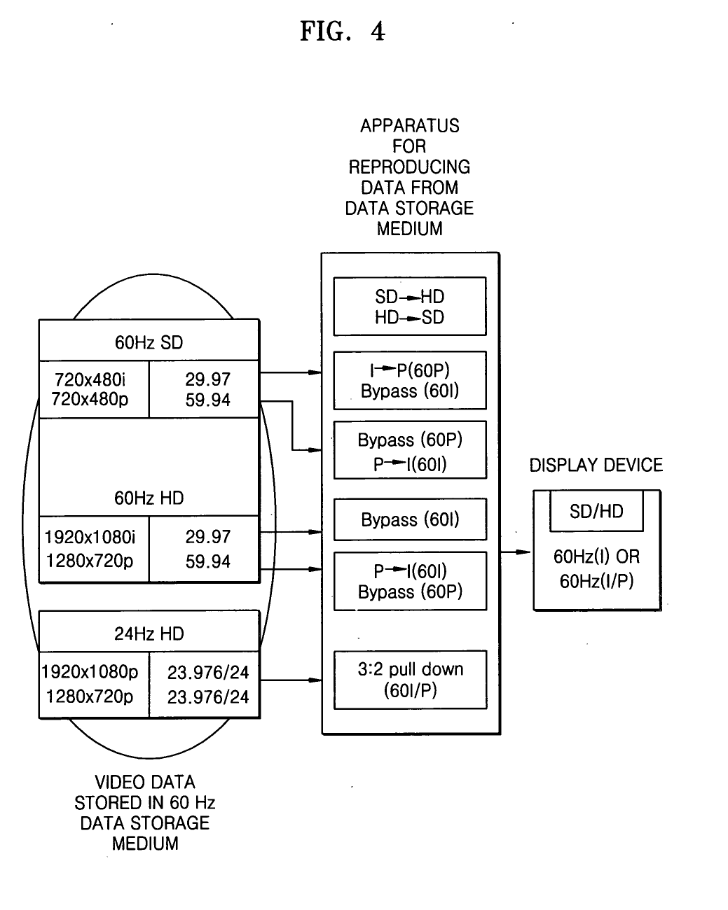

An operation of converting various types of 60 Hz video data to render the video data compatible with a display device that may only process 60 Hz video data will now be described with reference to FIG. 4. Referring to FIG. 4, video data may undergo one or both of a frame size conversion operation and a scan type conversion operation to become compatible with a display device. Suppose that the video data is 60 Hz video data, and the display device can only process 60 Hz video data. If the video data has a different frame size from a frame size supported by the display device, the apparatus to reproduce data from a data storage medium resizes the video data so that the video data becomes compatible with the 60 Hz display device. Specifically, if the video data is HD video data, but the 60 Hz display device cannot process HD video data, then the apparatus to reproduce data from a data storage medium converts the video data into SD video data. If the video data is SD video data, but the 60 Hz display device cannot process SD video data, then the apparatus to reproduce data from a data storage medium converts the video data into HD video data.

If the video data is progressive video data, but the 60 Hz display device cannot process progressive video data, then the apparatus to reproduce data from a data storage medium converts the video data into interlaced video data. If the video data is progressive video data, and the 60 Hz display device is able to process progressive video data, then the apparatus to reproduce data from a data storage medium bypasses the video data. Conversely, if the video data is interlaced video data, but the 60 Hz display device cannot process interlaced video data, then the apparatus to reproduce data from a data storage medium converts the video data into progressive video data. If the video data is interlaced video data, and the 60 Hz display device is able to process interlaced video data, then the apparatus to reproduce data from a data storage medium bypasses the video data. If the video data is progressive video data, and the 60 Hz display device is able to process both progressive video data and interlaced video data, then the apparatus to reproduce data from a data storage medium bypasses the video data. If the video data is interlaced video data, and the 60 Hz display device can process both progressive video data and interlaced video data, then the apparatus to reproduce data from a data storage medium may convert the video data into progressive video data because progressive video data is displayed with higher resolution than interlaced video data. However, if the video data is HD interlaced video data, the apparatus to reproduce data from a data storage medium bypasses the video data, regardless of whether the 60 Hz display device is able to process interlaced video data, because the amount of computation to compute interlaced video data having a 1920×1080i frame size into progressive video data having the same frame size is too great.

The following are various examples of conditions in which the display device is only able to process certain video data.

First, suppose that the display device is only able to process SD interlaced video data. If the video data has a 720×480i-29.97 format, the apparatus to reproduce data from a data storage medium bypasses the video data. If the video data has a 720×480p-59.94 format, the apparatus to reproduce data from a data storage medium converts the video data into interlaced video data. If the video data has a 1920×1080i-29.97 format, the apparatus to reproduce data from a data storage medium resizes the video data into SD video data. If the video data has a 1280×720p-59.94 format, the apparatus to reproduce data from a data storage medium resizes the video data and converts the resized video data into interlaced video data.

Next, suppose that the display device is only able to process HD interlaced video data. If the video data has a 720×480i-29.97 format, the apparatus to reproduce data from a data storage medium resizes the video data into HD video data. If the video data has a 720×480p-59.94 format, the apparatus to reproduce data from a data storage medium resizes the video data into HD video data and converts the resized video data into interlaced video data. If the video data has a 1920×1080i-29.97 format, the apparatus to reproduce data from a data storage medium bypasses the video data. If the video data has a 1280×720p-59.94 format, the apparatus to reproduce data from a data storage medium converts the video data into interlaced video data.

Next, suppose that the display device is able to process both SD interlaced video data and SD progressive video data. If the video data has a 720×480i-29.97 format, the apparatus to reproduce data from a data storage medium converts the video data into progressive data. If the video data has a 720×480p-59.94 format, the apparatus to reproduce data from a data storage medium bypasses the video data. If the video data has a 1920×1080i-29.97 format, the apparatus to reproduce data from a data storage medium resizes the video data into SD video data and converts the resized video data into progressive video data. If the video data has a 1280×720p-59.94 format, the apparatus to reproduce data from a data storage medium resizes the video data into SD video data.

Finally, suppose that the display device is able to process both HD interlaced video data and HD progressive video data. If the video data has a 720×480i-29.97 format, the apparatus to reproduce data from a data storage medium resizes the video data into SD video data and converts the resized video data into progressive video data. If the video data has a 720×480p-59.94 format, the apparatus to reproduce data from a data storage medium resizes the video data into SD video data. If the video data has a 1920×1080i-29.97 format or a 1280×720p-59.94 format, the apparatus to reproduce data from a data storage medium bypasses the video data because the amount of computation to convert the video data into progressive video data is too great.

A process of converting 24 Hz video data into 60 Hz interlaced video data or 60 Hz progressive video data through a 3:2 pull-down operation will be described later in further detail with reference to FIG. 6.

FIG. 5A is a diagram illustrating a process of converting progressive video data into interlaced video data. Referring to FIG. 5A, progressive video data is converted into interlaced video data by extracting only even-numbered or odd-numbered fields from the progressive video data.

FIG. 5B is a diagram illustrating a process of converting interlaced video data into progressive video data. Referring to FIG. 5B, interlaced video data is converted into progressive video data by repeatedly generating a new field using every two adjacent fields of the interlaced video data, in which case, each field of the interlaced video data is used twice so that the frame rate of the interlaced video data is maintained even after the interlaced video data is converted into progressive video data.

FIG. 6 is a diagram illustrating a 3:2 pull-down operation. Referring to FIG. 6, 24 frames may be converted into 60 fields using each frame to generate every two or three fields. This operation is called a 3:2 pull-down. Specifically, 24 Hz video data is converted into 60i or 60p video data through the 3:2 pull-down operation by generating five fields of interlaced video data using every pair of frames of progressive video data.

There are various rate conversion methods of increasing or decreasing a frame rate or field rate, other than those set forth herein. Thus, the apparatus to reproduce data from a data storage medium according to the described embodiments of the present invention is not restricted to the rate conversion methods set forth herein but is able to convert the format of video data using any of the various rate conversion methods.

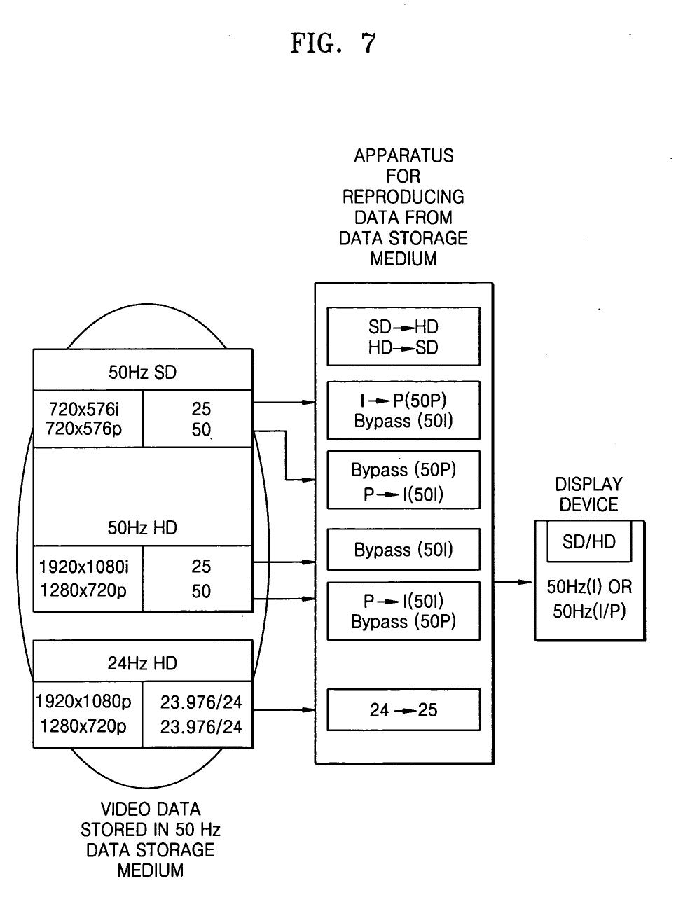

A process of converting the format of 50 Hz video data such that the video data is compatible with a 50 Hz display device will now be described with reference to FIG. 7. 50 Hz video data may only be processed by a 50 Hz display device and is stored in a separate data storage medium from 60 Hz video data. The 50 Hz display device may be able to process one or both of 50i video data and 50p video data. In addition, the 50 Hz display device may be able to process one or both of SD video data and HD video data. A data storage medium where video data that may be processed by the 50 Hz display device, i.e., 50 Hz video data, is recorded may store 50 Hz SD video data and/or 50 Hz HD video data. The data storage medium may further store 24 Hz HD video data together with 50 Hz SD and/or HD video data.

FIG. 7 illustrates a way in which a plurality of 50 Hz video data having different formats are converted so as to be compatible with a 50 Hz display device through a frame size conversion operation and/or a scan type conversion operation. Referring to FIG. 7, if the frame size of 50 Hz video data is different from a frame size supported by a display device, the 50 Hz video data is resized to be compatible with the display device. For example, if the 50 Hz video data is SD video data, but the display device cannot process SD video data, then the 50 Hz video data is resized into SD video data. If the 50 Hz video data is HD video data, but the display device cannot process HD video data, then the 50 Hz video data is resized into SD video data.

If the 50 Hz video data is created in a different scanning method from a scanning method supported by the display device, the 50 Hz video data undergoes a scan type conversion operation, i.e., either a progressive-to-interlaced conversion operation or an interlaced-to-progressive conversion operation. This scan type conversion operation is similar to the method that has already been described above with reference to FIG. 4, with the minor exception being that this scan type conversion operation deals with 50 Hz video data rather than 60 Hz video data. Thus, a detailed description thereof is omitted.

A data storage medium where the 50 Hz video data is recorded may further store 24 Hz video data. The 24 Hz video data may be converted in two different manners. First, the 24 Hz video data may be reproduced at a rate of 25 frames per second. The running time of the 24 Hz video data becomes shorter when the 24 Hz video data is reproduced at a rate of 25 frames per second than when the 24 Hz video data is reproduced at a rate of 24 frames per second by 25/24 seconds. When video data is reproduced at a higher rate than the required one, corresponding audio data should also be reproduced at the same frame rate as the frame rate at which the video data is reproduced. However, when audio data is reproduced at a higher rate than the required rate, a pitch thereof increases accordingly. Thus, returning the audio data to the original pitch thereof becomes necessary. Second, a frame may be generated for every 24 frames of the 24 Hz video data and then interpolated in a predetermined position in the 24 Hz video data. In this case, however, an observer may feel discontinuity in the reproduction of the 24 Hz video data. Thus, in order to prevent the 24 Hz video data from being discontinuously reproduced, a frame may be generated for every 24 frames of the 24 Hz video data and then interpolated in a random position in the 24 Hz video data so that the generated frame goes unnoticed by an observer of the reproduced video data.

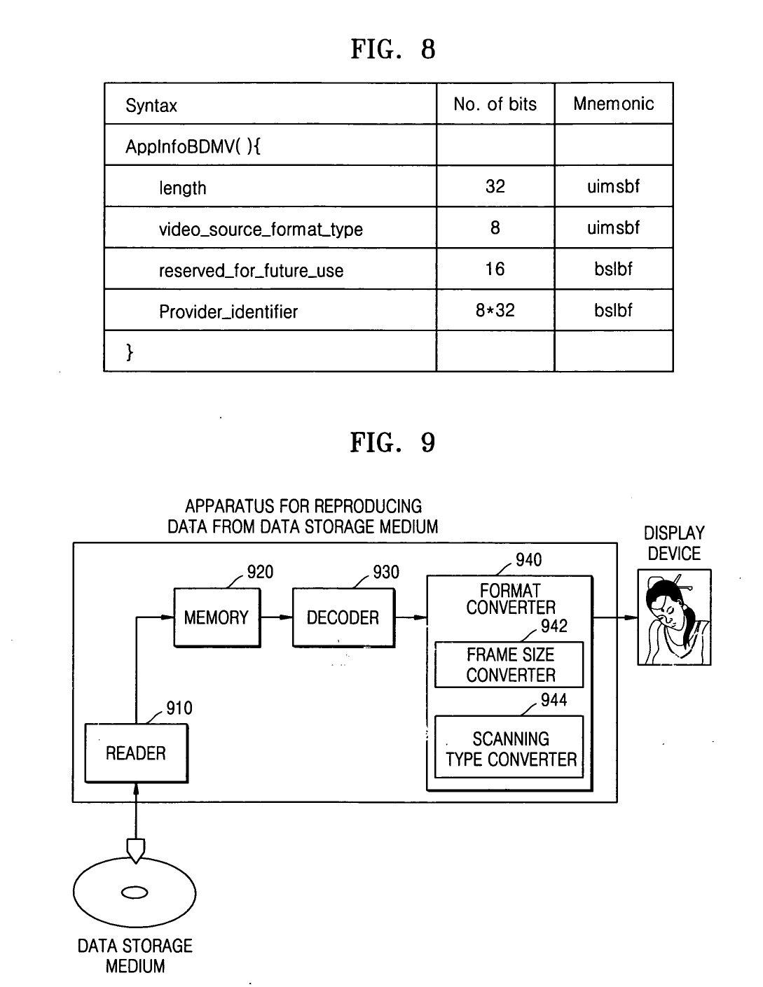

FIG. 8 is a diagram illustrating the format of video data containing video source format type information video_source_format_type. Referring to FIG. 8, one data storage medium has only one video source format type information video_source_format_type regardless of whether video data having the same format or having different formats are stored in the data storage medium. Video data stored in the data storage medium has a frame rate (or field rate) of 60 Hz (or 24 Hz) or a frame rate (or field rate) of 50 Hz (or 24 Hz), regardless of whether the video data is SD video data or HD video data. The video source format type information video_source_format_type is read from the data storage medium when the data storage medium is loaded in an apparatus to reproduce data from the data storage medium. The video source format type information video_source_format_type is used to determine whether the video data stored in the data storage medium is 60 Hz video data or 50 Hz video data.

The video source format type information video_source_format_type is also used to determine whether the video data stored in the data storage medium is SD video data or HD video data. A data storage medium to store 60 Hz video data is only able to store 60 Hz video data and 24 Hz video data. A data storage medium to store 50 Hz video data is only able to store 50 Hz video data and 24 Hz video data.

An apparatus to reproduce data from a data storage medium is classified into either an apparatus to reproduce 60 Hz data from a data storage medium or an apparatus to reproduce 50 Hz data from a data storage medium. The apparatus to reproduce 60 Hz data from a data storage medium reproduces 60 Hz data from the data storage medium and outputs the reproduced 60 Hz data to a display device for reproducing 60 Hz data. The apparatus to reproduce 50 Hz data from a data storage medium reproduces 50 Hz data from the data storage medium and outputs the reproduced 50 Hz data to a display device to reproduce 50 Hz data. Specifically, the apparatus to reproduce 60 Hz data from a data storage medium reads 60 Hz data from a 60 Hz data storage medium. Thereafter, the apparatus to reproduce 60 Hz data from a data storage medium bypasses the 60 Hz data read out from the 60 Hz data storage medium if the corresponding 60 Hz data is created in the same scanning method as a scanning method supported by the apparatus to reproduce 60 Hz data from a data storage medium. Otherwise, the apparatus to reproduce 60 Hz data from a data storage medium performs a progressive-to-interlaced conversion operation or an interlaced-to-progressive conversion operation on the 60 Hz data read out from the 60 Hz data storage medium. If the apparatus to reproduce 60 Hz data from a data storage medium reads 24 Hz data from the 60 Hz data storage medium, the apparatus performs a 3:2 pull-down operation on the 24 Hz data and then outputs the results.

Likewise, the apparatus to reproduce 50 Hz data from a data storage medium bypasses the 50 Hz data read out from the 50 Hz data storage medium if the corresponding 50 Hz data is created in the same scanning method as a scanning method supported by the apparatus to reproduce 50 Hz data from a data storage medium. Otherwise, the apparatus to reproduce 50 Hz data from a data storage medium performs a progressive-to-interlaced conversion operation or an interlaced-to-progressive conversion operation on the 50 Hz data read out from the 50 Hz data storage medium. If the apparatus to reproduce 50 Hz data from a data storage medium reads 24 Hz data from the 50 Hz data storage medium, the apparatus displays the 24 Hz data at a speed of 25/24 or displays the 24 Hz data repeating one of every 24 frames of the 24 Hz data.

Referring to FIG. 8, the video source format type information may be expressed as follows.
video_source_format_type=A∥B∥C∥D∥E
A (60 Hz SD): 720×480i-29.97, 720×480p-59.94
B (60 Hz HD): 1920×1080i-29.97, 1280×720p-59.94
C (50 Hz SD): 720×576i-25, 720×576p-50
D (50 Hz HD): 1920×1080i-25, 1280×720p-50
E (24 Hz HD): 1920×1080p-23.976, 1920×1100p-24, 1280×720p-23.976, 1280×720p-24.

Here, the video source format type information video_source_format_type may only be set to one of A, B, and E, one of C and D, or one of C, D, and E. The video source format type information video_source_format_type is used to determine whether video data stored in a corresponding data storage medium is 60 Hz video data or 50 Hz video data. In addition, the video source format type information video_source_format_type is also used to display the video data stored in the corresponding data storage medium with a display device compatible with the format of the corresponding video data. The video source format type information video_source_format_type includes information specifying whether the video data stored in the corresponding data storage medium is SD video data or HD video data.

FIG. 9 is a block diagram of an apparatus to reproduce data from a data storage medium according to an embodiment of the present invention. Referring to FIG. 9, the apparatus includes a reader 910, a memory 920, a decoder 930, and a format converter 940. A display device may be a 60 Hz display device or 50 Hz display device. The reader 910 reads video data stored in a storage medium and stores the video data in the memory 920. The decoder 930 decodes the video data stored in the memory 920. The format converter 940 converts the format of the decoded video data to be compatible with a format supported by the display device. The conversion of the format of the decoded video data has already been described above. The format converter 940 includes a frame size converter 942 and a scanning type converter 944. The frame size converter 942 converts SD video data into HD video data or vice versa. The scanning type converter 944 converts interlaced video data into progressive video data or vice versa.

The above-described method of reproducing data from a data storage medium may be written as a computer program. In addition, the computer program may be stored in a computer-readable data storage medium to be read and executed by a computer. Examples of the computer-readable data storage medium include a magnetic recording medium, an optical recording medium, and a carrier wave medium.

As is described above, according to the described embodiment of the present invention, converting video data having different formats to be compatible with a format supported by a display device so as to smoothly display the conversion results with the display device is possible.

Although embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A data storage medium on which video data is recordable and stored, comprising:
video source format type information to determine whether the stored video data is 50 Hz video data or 60 Hz video data,
wherein, when multiple video data having different formats are stored, the multiple video data include 60 Hz video data or 50 Hz video data.

2. The data storage medium of claim 1, wherein the multiple video data comprise 60 Hz video data and 24 Hz video data or comprise 50 Hz video data and 24 Hz video data.

3. The data storage medium of claim 1, wherein the 60 Hz video data comprises 60 Hz standard definition (SD) video data and/or 60 Hz high definition (HD) video data, and the 50 Hz video data comprises 50 Hz SD video data and/or 50 Hz HD video data.

4. The data storage medium of claim 1, wherein the video source format type information comprises information on a frame size, a frame rate or a field rate, and a scanning type of the stored video data.

5. The data storage medium of claim 4, wherein the information on the frame size of the stored video data stored specifies whether the stored video data is standard definition (SD) video data or high definition (HD) video data.

6. The data storage medium of claim 4, wherein the information on the frame rate or field rate of the stored video data specifies whether the stored video data stored has a frame rate or field rate of 60 Hz, 50 Hz, or 24 Hz.

7. The data storage medium of claim 4, wherein the information on the scanning type of the stored video data specifies whether the stored video data stored is interlaced video data or progressive video data.

8. An apparatus to reproduce video data from a data storage medium, comprising:
a reader to read the video data from the data storage medium;
a decoder to decode the read the video data; and
a format converter to convert the decoded video data into 50 Hz video data or 60 Hz video data according to video source format type information contained in the decoded video data.

9. The apparatus of claim 8, wherein, when multiple video data having different formats are recorded on the data storage medium, the format converter converts all of the multiple video data into 60 Hz video data or 50 Hz video data according to the video source format type information contained in each of the multiple video data.

10. The apparatus of claim 8, wherein, when 24 Hz video data is recorded on the data storage medium, the format converter converts the 24 Hz video data into 60 Hz video data or 50 Hz video data.

11. The apparatus of claim 8, wherein, when the scanning type of the stored video data is similar to that of a scanning type supported by a display, the video data is transmitted to the display while bypassing the format converter, and when the scanning type of the stored video data is not the same as the scanning type supported by the display, the format converter converts the corresponding video data from interlaced video data into progressive video data or from progressive video data from interlaced video data and then transmits the conversion results to the display.

12. The apparatus of claim 8, wherein the format converter includes:
a frame size converter to convert high definition (HD) video data into standard definition (SD) video data or to convert SD video data into HD video data; and
a scanning type converter to convert interlaced video data into progressive video data or converts progressive video data into interlaced video data.

13. The apparatus of claim 8, wherein the data storage medium has only one video source format type information regardless of whether video data having the same format or having different formats are stored in the data storage medium.

14. The apparatus of claim 13, wherein the video source format type information is read from the data storage medium when the data storage medium is loaded in the apparatus.

15. The apparatus of claim 14, wherein the video source format type information (video_source_format_type) is expressed by the following equality:
video_source_format_type=A∥B∥C∥D∥E, wherein
A (60 Hz SD): 720×480i-29.97, 720×480p-59.94,
B (60 Hz HD): 1920×1080i-29.97, 1280×720p-59.94,
C (50 Hz SD): 720×576i-25, 720×576p-50,
D (50 Hz HD): 1920×1080i-25, 1280×720p-50, and
E (24 Hz HD): 1920×1080p-23.976, 1920×1080p-24, 1280×720p-23.976, or 1280×720p-24.

16. The apparatus of claim 15, wherein the video source format type information is set to: A, B, or E; C or D; or C, D, or E.

17. A method of reproducing data from a data storage medium, comprising:
reading video data from a data storage medium;
decoding the read video data; and
converting the decoded video data into 50 Hz video data or 60 Hz video data according to video source format type information contained in the decoded video data.

18. The method of claim 17, wherein the converting includes:
converting high definition (HD) video data into standard definition (SD) video data or converting SD video data into HD video data; and
converting interlaced video data into progressive video data or converting progressive video data into interlaced video data.

19. A computer-readable storage medium encoded with processing instructions to cause a microprocessor to execute a method of reproducing data from a data storage medium, the method comprising:
reading video data from a data storage medium;
decoding the read video data; and
converting the decoded video data into 50 Hz video data or 60 Hz video data according to video source format type information contained in the decoded video data.

20. An apparatus to reproduce video data from a data storage medium, comprising:
a reader to read the video data, including video source format type information, from the data storage medium;
a decoder to decode the read video data such that the video source format type information is identified; and
a format converter to convert the decoded video data into video data having a first or second frequency according to the video source format type information contained in the decoded video data.

21. The apparatus of claim 20, wherein the video data recorded on the data storage medium includes multiple video data having different formats.

22. The apparatus of claim 21, wherein when the video data includes multiple video data, the format converter converts all of the multiple video data into video data having the first or second frequency according to the video source format type information contained in each of the multiple video data.

23. The apparatus of claim 20, wherein the video data recorded on the data storage medium includes video data having a third frequency.

24. The apparatus of claim 23, wherein when the video data recorded on the data storage medium includes video data having the third frequency, the format converter converts the video data having the third frequency into video data having the first or second frequency.

25. The apparatus of claim 20, further comprising a display to display the video data, wherein the scanning type of the stored video data is similar to that which is supported by the display.

26. The apparatus of claim 25, wherein when the scanning type of the stored video data is similar to the scanning type that is supported by the display, the video data is transmitted to the display while bypassing the format converter.

27. The apparatus of claim 25, wherein when the scanning type of the stored video data is not similar to the scanning type that is supported by the display, the format converter converts the corresponding video data from interlaced video data into progressive video data or from progressive video data from interlaced video data and then transmits the conversion results to the display.

28. The apparatus of claim 20, wherein the format converter comprises:
a frame size converter to convert high definition (HD) video data into standard definition (SD) video data or to convert SD video data into HD video data; and
a scanning type converter to convert interlaced video data into progressive video data or converts progressive video data into interlaced video data.

29. The apparatus of claim 20, wherein the data storage medium has only one video source format type information regardless of whether the video data stored in the data storage medium has the same format or different formats.

30. The apparatus of claim 29, wherein the video source format type information is read from the data storage medium when the data storage medium is loaded in the apparatus.

31. The apparatus of claim 30, wherein the video source format type information (video_source_format_type) is expressed by the following equality:
video_source_format_type=A∥B∥C∥D∥E, wherein
A (60 Hz SD): 720×480i-29.97, 720×480p-59.94,
B (60 Hz HD): 1920×1080i-29.97, 1280×720p-59.94,
C (50 Hz SD): 720×576i-25, 720×576p-50,
D (50 Hz HD): 1920×1080i-25, 1280×720p-50, and
E (24 Hz HD): 1920×1080p-23.976, 1920×1080p-24, 1280×720p-23.976, or 1280×720p-24.

32. The apparatus of claim 15, wherein the video source format type information is set to: A, B, or E; C or D; or C, D, or E.

33. The apparatus of claim 20, wherein the conversion of the decoded video data comprises at least one of a frame size conversion operation, a frame rate conversion operation, and a progressive-to-interlaced conversion operation or an interlaced-to-progressive conversion operation.

34. The apparatus of claim 33, further comprising a filter, wherein in the frame size conversion operation, video data is resized with the filter while preventing deformation of the video data.

35. The apparatus of claim 34, wherein in the rate conversion operation, a portion of the video data is repeatedly interpolated.

36. The apparatus of claim 25, wherein if the video data has a different frame size from a frame size supported by the display, the video data is resized so that the video data becomes compatible with the display.

37. The apparatus according to claim 25, wherein if the video data is high definition (HD) video data, but the display cannot process HD video data, the video data is converted into SD video data.

38. The apparatus according to claim 25, wherein if the video data is standard definition (SD) video data, but the display cannot process SD video data, the video data is converted into HD video data.

39. The apparatus according to claim 25, wherein if the video data is progressive video data, but the display cannot process progressive video data, the video data is converted into interlaced video data.

40. The apparatus according to claim 25, wherein if the video data is interlaced video data, but the display cannot process interlaced video data, the video data is converted into progressive video data.
